(19) United States
(12) Patent Application Publication
(10) Pub. No.: US 2021/0349218 A1
(43) Pub. Date: Nov. 11, 2021

(54) SYSTEM AND METHOD FOR PROCESSING MEASURED 3D VALUES OF A SCENE

(71) Applicant: BASLER AG, Ahrensburg (DE)

(72) Inventor: JENS DEKARZ, Bad Oldesloe (DE)

(73) Assignee: BASLER AG, Ahrensburg (DE)

(21) Appl. No.: 17/245,023

(22) Filed: Apr. 30, 2021

(30) Foreign Application Priority Data
May 5, 2020 (DE) 102020112120.2

(51) Int. Cl. G01S 17/894; G01S 7/497; G01S 17/08

(52) U.S. Cl. CPC G01S 17/894; G01S 17/08; G01S 7/497

(57) ABSTRACT

A system for processing measured 3D values of a scene is described. The 3D measurement values comprise first 3D measurement values acquired from a first perspective and second 3D measurement values acquired from a second perspective different from the first perspective. The fields of view of the first perspective and the second perspective are at least partially overlapping. The 3D measurement values have been acquired by one or more 3D measurement devices. The system comprises one or more processing units for multi-stage processing of the 3D measurement values using a hierarchical location uncertainty model which takes into account various measurement errors of the 3D measurement values and/or boundary conditions for the 3D measurement values, which are dependent on the geometry of the scene and the first perspective and/or the second perspective.

### CROSS REFERENCE TO FOREIGN PRIORITY APPLICATION

The present application claims the benefit under 35 U.S.C. §§ 119(b), 119(e), 120, and/or 365(c) of German Application No. 10 2020 112120.2 filed May 5, 2020.

### FIELD OF THE INVENTION

The invention relates to a system and method for processing measured 3D values of a scene, and to a computer program comprising instructions which, when the program is executed by a computer, cause the computer to execute the method for processing measured 3D values of a scene.

### BACKGROUND OF THE INVENTION

In order to capture and then process a scene in three dimensions (3D), it is common to determine the 3D values of the scene using a device for 3D measurement. Such a device can use different technologies, such as time-of-flight (ToF), structured light (e.g., D. Scharstein and R. Szeliski, “High accuracy stereo depth maps using structured light,” CVPR, Madison, Wis., USA, June 2003), depth from focus (e.g., J. Ens and P. Lawrence, “An investigation into methods for determining depth from focus,” IEEE Transactions on Pattern Recognition, Vol. 15, No. 2, February 1993), depth from stereo (e.g., P. Kamencay et al., “Improved depth map estimation for stereo images based on hybrid method,” Radioengineering, Vol. 21, No. 1, 2012) and so on, or use combinations thereof. In this regard, the 3D measurement values may be in various forms. Common forms include 3D point clouds, 3D grids, regular 3D structures such as voxel grids, or 3D tree structures such as kd- or octrees. The different forms describe the same information in different ways. Conversion from one form to another is therefore typically possible.

In general, the 3D acquisition of a scene from only one perspective does not yet provide a complete description of the scene, since only the 3D values pᵢ=(xᵢ, yᵢ, zᵢ,1) with i∈[1 . . . N] of the surfaces visible from this perspective can be determined. A remedy for this is the use of M different perspectives, for each of which a set of corresponding 3D values Pⱼ with j∈[1 . . . M] is determined. The different perspectives can, for example, be acquired simultaneously with several devices for 3D measurement (this is particularly advantageous for moving scenes), or a moving 3D measurement device acquires the different perspectives at different times (this is particularly possible for static scenes). The number, position and orientation of the perspectives are preferably selected in such a way that the scene is captured as completely and without gaps as possible. Partial overlaps of the fields of view are usually unavoidable. The resulting redundancy in the determined 3D measurement values is accepted herein.

Since the 3D measurement values j associated with the individual perspectives pᵢⱼ are generally initially acquired in a coordinate system associated with each perspective, they must be transferred into a common coordinate system to generate an overall description of the scene. This is facilitated by a respective coordinate transformation pᵢⱼ′=Tⱼ·pᵢⱼ. Herein

$$T = ( \begin{matrix}{r}_{11} & {r}_{12} & {r}_{13} & {t}_{1} \\ {r}_{21} & {r}_{22} & {r}_{23} & {t}_{2} \\ {r}_{31} & {r}_{32} & {r}_{33} & {t}_{3} \\ 0 & 0 & 0 & 1\end{matrix} ) \qquad ( 1 )$$

is an affine 3D transformation consisting of a rotation R=[r₁₁ . . . r₃₃] and a translation t=[t₁ . . . t₃]. The parameters R and t can result from the design of the 3D measurement device, the one-time or periodic application of a calibration procedure, or a continuous run-time calibration. Combining the transformed 3D measurement values provides an overall description of the scene from the measurements of all perspectives.

Usually, further processing of the overall description of the scene takes place. This may include segmentation, clustering, object search or the like. In addition or alternatively, the 3D measurement values can also be visualized or passed on to other technical devices, such as a gripper arm, a drive or a sorting device.

One problem here is that the measurement accuracy of devices for 3D measurement, e.g., ToF cameras, is inherently limited. The determined 3D measurement values are distorted by noise and usually afflicted with various systematic errors. Therefore, the merged 3D measurement values are usually processed before further processing. In practice, standard methods for outlier suppression and noise reduction are used, for example local operators such as mean value filters, median filters or bilateral filters.

Calibration data are also generally subject to errors. In order to reduce the influence of such errors, methods are often used for fine correction of the perspectives from the determined 3D measurement values at run-time. For example, the iterative closest point, ICT, algorithm is widely used to efficiently minimize the difference between two 3D point clouds (e.g., P. J. Besl and N. D. McKay, “A method for registration of 3D shapes,” IEEE Transaction on Pattern Analysis and Machine Intelligence, Vol. 14, No. 2, 1992).

Within the framework of the known procedure described so far, consistency and isotropy of the data are usually implicitly assumed. For both systematic errors and noise, it is preferable to assume independence of location and direction. In practice, however, this is not true, or only to a limited extent.

For example, prior art 3D measurement devices exhibit particular non-ideal characteristics depending on the technology used. These lead to an individual measurement error (location uncertainty) for each 3D point, which can vary over the set of 3D measurement values and depends, for example, on the device itself, the location, the perspective, and/or the scene.

For example, for camera-based 3D measurement devices, the lateral measurement inaccuracy generally increases with distance. For stereo camera systems, the distance inaccuracy even increases disproportionately with distance. Moreover, their measurement noise depends in strength and distribution on the contrast and texture in the local environment of the pixels and is thus dependent on location and scene. Furthermore, outliers can occur due to misallocations of corresponding pixels.

ToF cameras, in turn, exhibit a whole range of measurement errors (see D. Lefloch et al., “Technical Foundation and Calibration Methods for Time-of-Flight Camera,” in “Time-of-Flight and Depth Imaging. Sensors, Algorithms, and Applications,” Springer, 2013). The most important are: (1) Photon noise, which leads to a spatial noise component of the measurements in the radial direction. For each pixel, this depends on the in-camera illumination, the background light, the distance to the scene point, and its reflectivity. (2) Multipath and stray light errors, which result from the unwanted superposition of different light paths. They also act in the radial direction and are highly scene dependent. (3) Periodically modulated ToF cameras also exhibit a measurement result that is ambiguous in the radial direction dᵢₖ′=k·d_{R}+dᵢ where k∈ [symbol] ₀ and dᵢ is the measured distance, dᵢₖ′ is the possible real distance and d_{R} denotes the unambiguous measurement range.

For devices for 3D measurement using other methods, e.g., structured light, depth from focus, etc., similarly complex error phenomena can be listed.

It follows from the foregoing that the prior art description of a scene is erroneous and inaccurate. The 3D measurement values for different perspectives (whether acquired simultaneously with several devices for 3D measurement or at different times with one 3D measurement device) can thus lead to locally different, contradictory results.

Previous approaches try to reduce these measurement errors for each perspective or device for 3D measurement separately, for example, by calibration steps, components with improved properties, more complex modulation methods, or a combination of different methods. This is partially effective for certain errors, for others there are no successful approaches so far.

It would therefore be desirable to provide for new approaches to, partially or completely, identify and/or reduce particularly anisotropic, local and scene-dependent measurement errors based on redundant data resulting from the 3D acquisition of the same scene from different perspectives by one or more devices for 3D measurement.

### SUMMARY OF THE INVENTION

It is an object of the invention to provide a system and a method for processing measured 3D values of a scene, which make it possible to, partially or completely, identify and/or reduce particularly anisotropic, local, and scene-dependent measurement errors based on redundant data. Furthermore, it is an object of the invention to provide a computer program comprising instructions which, when the program is executed by a computer, cause the computer to execute the method for processing measured 3D values of a scene.

According to a first aspect of the invention, there is provided a system for processing measured 3D values of a scene, wherein the 3D measurement values comprise first 3D measurement values acquired from a first perspective and second 3D measurement values acquired from a second perspective different from the first perspective, wherein the fields of view of the first perspective and the second perspective are at least partially overlapping, wherein the 3D measurement values have been acquired by one or more devices for 3D measurement, wherein the system comprises: one or more processing units for multi-stage processing of the 3D measurement values using a hierarchical location uncertainty model which takes into account various measurement errors of the 3D measurement values and/or boundary conditions for the 3D measurement values, which are dependent on the geometry of the scene and the first perspective and/or the second perspective.

The invention is based on the inventor's realization that the various types of measurement errors of the 3D measurement values and/or the boundary conditions for the 3D measurement values, which are dependent on the geometry of the scene and the first perspectives and/or the second perspective, can be taken into account by means of a hierarchical location uncertainty model, and, in particular, that multi-stage processing using the hierarchical location uncertainty model makes it possible to determine the location uncertainties of the 3D measurement values very robustly and with high accuracy. This may allow unreliable 3D measurement values to be better identified and, if necessary, removed or corrected to provide an improved 3D description of the scene.

It is preferred that the one or more processing units are adapted, using the hierarchical location uncertainty model for 3D measurement values of the first 3D measurement values and/or for 3D measurement values of the second 3D measurement values, to determine a respective location uncertainty function and to adapt it in stages.

It is further preferred that the one or more processing units comprise at least a first processing unit that is adapted, using a lowest-stage location uncertainty model for the 3D measurement values of the first 3D measurement values and/or the 3D measurement values of the second 3D measurement values, to determine a respective location uncertainty function, wherein the lowest-stage location uncertainty model takes into account measurement errors which can be determined for each 3D measurement value of the 3D measurement values independently of the other 3D measurement values of the 3D measurement values.

In particular, it is preferred that the lowest-stage location uncertainty model accounts for one or more of the following measurement errors: (i) depth-dependent lateral measurement errors, for example due to a sensor pixel grid of the one or more 3D measurement devices; (ii) measurement errors due to sensor noise of the one or more 3D measurement devices; (iii) measurement errors due to geometric calibration errors; (iv) measurement errors due to linearity errors of the one or more 3D measurement devices; and (v) periodic ambiguities of the 3D measurement values.

It is preferred that the one or more processing units comprise at least a second processing unit which is adapted to process the location uncertainty functions for the 3D measurement values of the first 3D measurement values and/or the 3D measurement values of the second 3D measurement values using a first higher-stage location uncertainty model, wherein the first higher-stage location uncertainty model takes into account dependencies between the 3D measurement values of the first 3D measurement values and/or between the 3D measurement values of the second 3D measurement values that are dependent on the geometry of the scene and the respective perspective.

In particular, it is preferred that the first higher-stage location uncertainty model takes into account one or more of the following measurement errors and/or boundary conditions that are dependent on the geometry of the scene and the respective perspective: (i) measurement errors due to scattered light; (ii) measurement errors due to multipath effects; (iii) boundary conditions due to spatially contiguous surfaces in the scene; and (iv) boundary conditions due to 3D edges in the scene.

It is further preferred that the one or more processing units comprise at least a third processing unit that is adapted to transfer the 3D measurement values of the first 3D measurement values and the 3D measurement values of the second 3D measurement values as well as the location uncertainty functions for the 3D measurement values of the first 3D measurement values and the location uncertainty functions for the 3D measurement values of the second 3D measurement values into a common coordinate system by means of a respective coordinate transformation.

It is further preferred that the one or more processing units comprise at least a fourth processing unit that is adapted to process the location uncertainty functions for the 3D measurement values of the first 3D measurement values and/or the 3D measurement values of the second 3D measurement values using a second higher-stage location uncertainty model, wherein the second higher-stage location uncertainty model takes into account a redundancy of the first 3D measurement values and the second 3D measurement values that depends on the geometry of the scene, the first perspective and the second perspective.

It is preferred that the one or more processing units comprise at least a fifth processing unit that is adapted to perform one or more of the following processing steps: (i) determining, on the basis of the location uncertainty functions in the common coordinate system, a reliability of the 3D measurement values of the first 3D measurement values and/or the 3D measurement values of the second 3D measurement values; (ii) determining, on the basis of the location uncertainty functions of corresponding 3D measurement values of the first 3D measurement values and the second 3D measurement values; and (iii) determining, on the basis of the location uncertainty functions in the common coordinate system, an overall location uncertainty function and determining new 3D measurement values by sampling the overall location uncertainty function.

It is further preferred that the system further comprises the one or more devices for 3D measurement.

It is preferred that the one or more devices for 3D measurement comprise one or more time-of-flight, ToF, cameras.

It is further preferred that at least one of the one or more devices for 3D measurement comprises the at least one first processing unit and, optionally, the at least one second processing unit.

According to another aspect of the invention, there is provided a method of processing measured 3D values of a scene, wherein the 3D measurement values comprise first 3D measurement values acquired from a first perspective and second 3D measurement values acquired from a second perspective different from the first perspective, wherein the fields of view of the first perspective and the second perspective are at least partially overlapping, wherein the 3D measurement values have been acquired by one or more 3D measurement devices, wherein the method comprises: multi-stage processing of the 3D measurement values using a hierarchical location uncertainty model which takes into account various measurement errors of the 3D measurement values and/or boundary conditions for the 3D measurement values, which are dependent on the geometry of the scene and the first perspective and/or the second perspective.

According to another aspect of the invention, there is provided a computer program comprising instructions which, when the program is executed by a computer, cause the computer to perform the aforementioned method.

It is understood that the system and method described above, as well as the computer program herein described have similar and/or identical preferred embodiments, particularly as defined in the dependent claims set forth below.

It is understood that a preferred embodiment of the invention may also be any combination of the dependent claims with the corresponding independent claim.

### BRIEF DESCRIPTION OF THE DRAWINGS

Preferred embodiments of the invention are described in more detail below with reference to the accompanying figures, wherein:

FIG. 1 schematically and exemplarily shows an embodiment of a system for processing measured 3D values of a scene, and

FIG. 2 shows a flowchart illustrating an embodiment of a method for processing measured 3D values of a scene.

### DETAILED DESCRIPTION OF THE EMBODIMENTS

In the figures, identical or corresponding elements or units are provided with identical or corresponding reference signs, respectively. If an element or unit has already been described in connection with a figure, a detailed description may be omitted in connection with another figure.

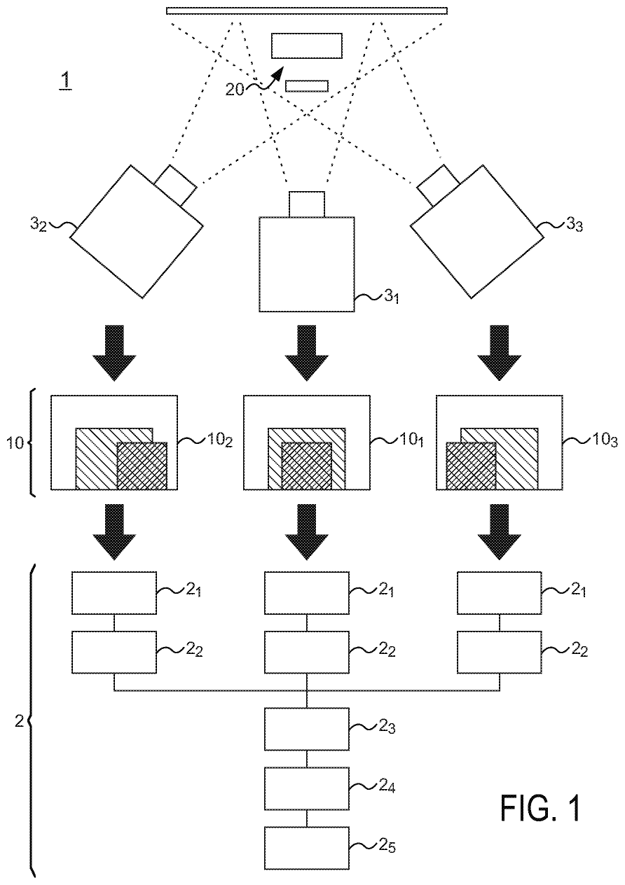

An embodiment of a system 1 for processing measured 3D values 10 of a scene 20 is schematically and exemplarily shown in FIG. 1. The system 1 comprises one or more devices 3₁, 3₂ for 3D measurement and one or more processing units 2 for multi-stage processing of the 3D measurement values 10 using a hierarchical location uncertainty model which takes into account various kinds of measurement errors of the 3D measurement values 10 and/or boundary conditions for the 3D measurement values 10, which are dependent on the geometry of the scene 20 and the first perspective and/or the second perspective. In this embodiment, the one or more devices 3₁, 3₂ for 3D measurement comprise one or more time-of-flight, ToF, cameras.

The 3D measurement values 10 are captured by the one or more ToF cameras 3₁, 3₂. The 3D measurement values 10 include first 3D measurement values 10₁ acquired from a first perspective, and second 3D measurement values 10₂ acquired from a second perspective different from the first perspective. The fields of view of the first perspective and the second perspective are at least partially overlapping.

The one or more processing units 2 are adapted, using the hierarchical location uncertainty model for 3D measurement values of the first 3D measurement values 10₁ and/or for 3D measurement values of the second 3D measurement values 10₂, to determine a respective location uncertainty function wᵢⱼ(x, y, z) and to adapt it in stages.

### I. Lowest-Stage Location Uncertainty Model

In this embodiment, the one or more processing units 2 comprise at least a first processing unit 2₁ that is adapted, using a lowest-stage location uncertainty model for the 3D measurement values of the first 3D measurement values 10₁ and/or for the 3D measurement values of the second 3D measurement values 10₂, to determine a respective location uncertainty function wᵢⱼ(x, y, z), wherein the lowest-stage location uncertainty model takes into account measurement errors which can be determined for each 3D measurement value of the 3D measurement values 10 independently of the other 3D measurement values of the 3D measurement values 10.

For each perspective j, it is possible to estimate for each 3D measurement pᵢⱼ=(xᵢ, yᵢ, zᵢ, 1) with i∈[1 . . . N] a location uncertainty function, for example in the form of a probability density wᵢⱼ(x, y, z), for its correct location in space.

The location uncertainty function wᵢⱼ(x, y, z) is composed of the probability distributions of the various measurement errors which can be determined for each 3D measurement value 10 independently of other 3D measurement values 10.

a. Lateral Error:

A lateral error results, for example, from the pixel grid of the sensor of the respective ToF camera 3₁, 3₂. It is a uniform distribution with width b, which depends on the z-coordinate of the respective 3D measurement value pᵢⱼ:

$$b = \pm z \cdot \frac{T}{2 f} \qquad ( 2 )$$

where T is the pixel pitch and f is the focal length of the ToF camera 3₁, 3₂.

b. Sensor Noise:

The noise of the sensor and the electronics of the respective ToF camera 3₁, 3₂ causes an error acting in radial direction, which is approximately normally distributed and whose standard deviation Ur can be estimated by means of the so-called confidence C to yield:

σᵣ=k·C (3)

where k is a constant.

The confidence C provides for each measured 3D value pᵢⱼ a criterion for the amplitude of its distance noise. It is usually provided by the ToF camera 3₁, 3₂ itself, but can alternatively be estimated from the intensity values per 3D measurement value pᵢⱼ. The intensity values are also typically provided by the ToF camera 3₁, 3₂.

c. Geometric Calibration Errors:

During the calibration of the ToF cameras 3₁, 3₂ the rotation R and translation t of the camera coordinate system are determined with respect to a global coordinate system. The errors occurring in the process, as well as changes in the setup after calibration, for example, due to temperature changes or vibrations, can be assumed to be normally distributed in a first approximation.

Here the error of the translation t acts in all directions with the standard deviations σₜₓ, σ_{ty}, σ_{tz}. Tilting errors act laterally, but are dependent on the distance d of the respective 3D point. For small angular errors with σₚₐₙ, σₜᵢₗₜ, the following applies approximately:

σₚₓ=σₚₐₙ·d

σ_{ty}=σₜᵢₗₜ·d (4)

Errors in rotation about the optical axis act laterally and depend on the distance Δx, Δy of the 3D point to the axis. For small angular errors σᵣₒₗₗ, the following applies approximately:

σᵣₓ=σᵣₒₗₗ·Δy

σ_{ry}=σᵣₒₗₗ·Δx

The standard deviations of the calibration errors are thus given as

σₓ=σₜₓ+σₚₓ+σᵣₓ

σ_{y}=σ_{ty}+σ_{ty}+σ_{ry}

σ_{z}=σ_{tz} (6)

d. Linearity Error:

The ToF cameras 3₁, 3₂ generally exhibit a substantial linearity error despite the usual internal quality measures. This also acts in the radial direction and can be described as a normal distribution in a first approximation:

σᵣ=const (7)

e. Overall Density:

The overall density wᵢⱼ(x, y, z), i.e., the location uncertainty function, is then obtained for each 3D measured value pᵢⱼ of a respective perspective j from the convolution or the product of the probability densities of the individual effects.

f. Periodic Ambiguities:

A distinctive feature of the ToF cameras 3₁, 3₂ is the ambiguity of the results in the radial direction due to the periodic modulation. As already explained, the actual distance is dᵢₖ′=k·d_{R}+dᵢ, where k∈ [symbol] ₀ and dᵢ is the measured distance, dᵢₖ′ is the possible real distance, and d_{R} denotes the unique measurement range.

The number of possibilities is theoretically infinite, but in practice can be narrowed down to typical values Q in a range from 3 to 5. The probability density functions wᵢⱼ(x, y, z) found so far repeat themselves therefore in radial direction Q times to

$${w}_{i j} ( x , y , z ) = \frac{1}{Q} {\sum }_{k} {w}_{i j} ( x - k b {x}_{ij} , y - k b {y}_{ij} , z - k b {z}_{i j} ) \qquad ( 8 )$$

with b=D/\sqrt{xᵢⱼ²+yᵢⱼ²+zᵢⱼ²}.

### II. First Higher-Stage Location Uncertainty Model

In this embodiment, the one or more processing units 2 comprise at least a second processing unit 2₂ that is adapted to adapt the location uncertainty functions wᵢⱼ(x, y, z) for the 3D measurement values of the first 3D measurement values 10₁ and/or the 3D measurement values of the second 3D measurement values 10₂ using a first higher-stage location uncertainty model, wherein the first higher-stage location uncertainty model takes into account dependencies between the 3D measurement values of the first 3D measurement values 10₁ and/or between the 3D measurement values of the second 3D measurement values 10₂ that are dependent on the geometry of the scene 20 and the respective perspective.

The dependencies available between the 3D measurement values pᵢⱼ of a respective perspective j can also each be described as a location uncertainty function, e.g., as probability density wᵢⱼ(x, y, z). The location uncertainty function wᵢⱼ (x, y, z) is composed of the probability distributions of the different scene/perspective dependent error sources:

a. Surfaces:

The measured 3D values pᵢⱼ are usually located on spatially contiguous surfaces. From this, probability relations of a 3D measured value pᵢⱼ to 3D measurement values pᵢⱼ of its neighbourhood can be derived, which can be used to reduce the location uncertainty wᵢⱼ(x, y, z). This is equivalent to applying smoothing and outlier filters to the data from a ToF camera 3₁, 3₂. Since these are generally already part of the processing in the ToF camera 3₁, 3₂, this approach is not described further in this example.

b. 3D Edges:

Due to the process, the 3D measurement values pᵢⱼ of points at surface or 3D edges are mixed results of foreground and background distances. These points are therefore assigned an arbitrary, incorrect distance, depending on the scene and the modulation method of the ToF camera 3₁, 3₂. The proximity of a 3D point to a 3D edge can now be determined via its neighborhood, and a probability density for belonging to foreground or background can be assigned. This corresponds in effect to an edge-preserving filter and is often already integrated in the ToF camera 3₁, 3₂. Therefore, this approach is also not described further in this example.

c. Stray Light:

The optics of the ToF cameras 3₁, 3₂ scatter a part of the light to be imaged onto one pixel onto all other pixels. As a result, the light travel time to be measured in each pixel overlaps with other, unwanted travel times and thus leads to measurement errors.

The resulting error depends on the respective scene, the scattering behavior of the camera optics and the concrete ToF method given by the modulation, the sensor principle and the calculation scheme. An exact calculation is complex and requires detailed knowledge about the implementation of the ToF camera 3₁, 3₂.

However, with simplifying assumptions it is possible to estimate the error.

An example for a useful estimation of the error eᵢⱼ is based on the intensity image of the self-illumination hᵢⱼ of the ToF camera 3₁, 3₂ and the distance data dᵢⱼ per pixel:

$${e}_{i j} \approx ( \frac{1}{{\sum }_{k} {h}_{k j} \cdot {psf}_{i - k}} \cdot {\sum }_{k} {d}_{k j} {h}_{k j} \cdot {psf}_{i - k} ) - {d}_{i j} \qquad ( 9 )$$

It is assumed that
the point spread function psf of the camera optics is known,
the superposition of the light paths can be linearly approximated with respect to the 3D measurement values, and
no light from the ToF camera 3₁, 3₂ falls on objects outside the field of view. The probability density wₛ of the scattered light error can be modeled, for example, as a uniform distribution:

$${w}_{s} = \{ \begin{matrix}{d}_{V i j} < d \leq {d}_{H i j} \text{:} \frac{1}{{d}_{H i j} - {d}_{V i j}} \\ sonst \text{:} 0\end{matrix} \qquad ( 10 )$$

with d_{Vij}=dᵢⱼ+eᵢⱼ−kₛ|eᵢⱼ| and d_{Hij}=dᵢⱼ+eᵢⱼ+kₛ|eᵢⱼ|. The parameter kₛ is used here to compensate for model inaccuracies.

d. Multipath Effects:

A 3D point in the scene is illuminated not only by a direct path but also by indirect paths via other objects. Here, too, a superposition of different travel times and thus distances takes place. As in the case of scattered light, the resulting error depends on the respective scene, the position of the object surfaces in space and the concrete ToF procedure given by the modulation, the sensor principle and the calculation scheme. An exact calculation is complex here and requires detailed knowledge of the implementation of the ToF camera 3₁, 3₂.

However, with simplifying assumptions it is again possible to estimate the error.

A very simple estimate of the maximum error is:

$${e}_{i} \approx \frac{m}{{h}_{i}} \cdot {\sum }_{k}^{{N}_{i}} \frac{{d}_{i k} + {d}_{k} - {d}_{i}}{{( {d}_{i k} + q )}^{2}} \cdot {h}_{k} \qquad ( 11 )$$

Here, dᵢₖ′j are respective distances between two points i and k of the perspective j. The parameters m and q are used to compensate for the model inaccuracies.

It is assumed here that:
the superposition of the light paths can be approximated linearly,
no light from the ToF camera 3₁, 3₂ falls on objects outside the image field,
all surfaces are Lambertian radiators, and
indirect paths only run over one additional area.

The probability density wₘ of the multipath error can again be modeled as a uniform distribution:

$${w}_{m} = \{ \begin{matrix}{d}_{V i j} < d \leq {d}_{H i j} \text{:} \frac{1}{{d}_{H i j} - {d}_{V i j}} \\ sonst \text{:} 0\end{matrix} \qquad ( 12 )$$

with d_{Vij}=dᵢⱼ+eᵢⱼ−k|eᵢⱼ| and d_{Hij}=dᵢⱼ+eᵢⱼ+k|eᵢⱼ|. The parameter kₘ is used here to compensate for model inaccuracies.

e. Overall Density:

The overall density wᵢⱼ(x, y, z), i.e., the location uncertainty function, of this stage is obtained for each 3D measurement value pᵢⱼ of a respective perspective j from the convolution or the product of the previous probability densities wᵢⱼ(x, y, z) of the 3D measurement values pᵢⱼ of the previous stage and the probability densities of the mentioned scene/perspective dependent effects.

### III. Second Higher-Stage Location Uncertainty Model

In this embodiment, the one or more processing units 2 comprise at least one third processing unit 2₃ that is adapted to transfer the 3D measurement values of the first 3D measurement values 10₁ and the 3D measurement values of the second 3D measurement values 10₂ as well as the location uncertainty functions for the 3D measurement values of the first 3D measurement values 10₁ and the location uncertainty functions for the 3D measurement values of the second 3D measurement values 10₂ into a common coordinate system by means of a respective coordinate transformation. In this embodiment, the densities wᵢⱼ(x, y, z) are transferred into the common coordinate system.

Furthermore, in this embodiment, the one or more processing units 2 comprise at least a fourth processing unit 2₄ that is adapted to adapt the location uncertainty functions wᵢⱼ(x, y, z) for the 3D measurement values of the first 3D measurement values 10₁ and/or the 3D measurement values of the second 3D measurement values 10₂ using a second higher-stage location uncertainty model, wherein the second higher-stage location uncertainty model takes into account a redundancy of the first 3D measurement values 10₁ and the second 3D measurement values 10₂ that depends on the geometry of the scene, the first perspective and the second perspective.

The dependencies between the 3D measurement values pᵢⱼ of the different perspectives j, which are caused by the system setup, the scene and, if applicable, the technologies used, can also be described in each case as a location uncertainty function, e.g., as probability density wᵢⱼ(x, y, z).

The location uncertainty function wᵢⱼ (x, y, z) is composed of the probability distributions of the various cross-camera dependencies and effects:

a. Redundancy of Perspectives:

Objects of the scene are projected redundantly as point sets. Due to the effects mentioned above, the different projections are not congruent but similar. Therefore, the location uncertainty wᵢⱼ(x, y, z) of a 3D measurement pᵢⱼ of the perspective j can be narrowed down, if further points were found in its spatial environment in the other perspectives.

Refined location uncertainties of a 3D measured value pᵢⱼ can be obtained, for example, by:

$${w}_{i j} ( x , y , z ) = {w}_{i j} ( x , y , z ) \cdot \frac{1}{M} {\sum }_{M}^{m} {\sum }_{{N}_{m}}^{n} {w}_{n m} ( x , y , z ) \qquad ( 13 )$$

where M is the number of cameras and N₁ indicates the number of points per ToF camera.

This assumes that
each ToF camera 3₁, 3₂ generally provides a laterally dense, contiguous point cloud, and
the location uncertainty of a measured point pᵢⱼ is greater than the distance to its spatially nearest neighbour.

b. Other Usable Effects:

i. Concealments:

Surfaces in space are generally opaque, i.e., objects can obscure other objects in one perspective j. Based on the densities wᵢⱼ(x, y, z) found so far, probabilities for the occlusions of 3D measurement values pᵢⱼ can be estimated and on this basis their densities can be reduced.

ii. Neighborhood:

On a surface, adjacent 3D points have very similar positions. From this, probability relationships between neighboring 3D points can be derived, which can be used to reduce location uncertainty. This corresponds, for example, to a subsequent filter on the 3D point cloud.

iii. Additional Point Properties:

Typically, the ToF cameras 3₁, 3₂ provide information on additional properties, such as background brightness or color, for each measured point in addition to the 3D coordinates. A similarity measure of these properties can be taken into account when merging the data of the different perspectives j. For this purpose, Eq. (13) can be suitably extended.

c. Overall Densities:

The overall densities wᵢⱼ(x, y, z), i.e., the location uncertainty function, of this stage is obtained for each 3D measurement value pᵢⱼ of a respective perspective j from the convolution or the product of the previous probability densities wᵢⱼ(x, y, z) of the 3D measurement values pᵢⱼ according to Eq. (12) and the probability densities of the system-wide effects.

### IV. Further Processing

In this embodiment, the one or more processing units 2 comprise at least a fifth processing unit 2₅ that is adapted to perform one or more of the following processing steps: (i) determining, on the basis of the location uncertainty functions wᵢⱼ(x, y, z) in the common coordinate system, a reliability of the 3D measurement values of the first 3D measurement values 10₁ and/or the 3D measurement values of the second 3D measurement values 10₂; (ii) determining, on the basis of the location uncertainty functions wᵢⱼ(x, y, z) of corresponding 3D measurement values of the first 3D measurement values 10₁ and the second 3D measurement values 10₂, corrected 3D measurement values; and (iii) determining, on the basis of the location uncertainty functions wᵢⱼ(x, y, z) in the common coordinate system, an overall location uncertainty function w(x, y, z) and determining new 3D measurement values by sampling the overall location uncertainty function w(x, y, z).

A possible implementation of these procedural steps could be as follows:

In order to first restrict the result only to the set P of sufficiently reliable 3D measurement values pᵢⱼ one can e.g. apply a threshold value T:

P={pᵢⱼ|max wᵢⱼ(x,y,z)>T} (14)

The optimal positions of the found 3D measurement values pᵢⱼ now correspond to the locations of the maxima of wᵢⱼ(x, y, z):

pᵢⱼ′=argmax_{x,y,z}wᵢⱼ(x,y,z) (15)

Here, pᵢⱼ′ is the corrected i-th point of the j-th perspective and wᵢⱼ(x, y, z) describes its remaining location uncertainty.

By summing the densities wᵢⱼ(x, y, z) of all 3D measurement values pᵢⱼ of all perspectives j an overall location uncertainty function w(x, y, z), which tells how likely any 3D point (x, y, z) is a real object point, can be determined:

$$w ( x , y , z ) = {\sum }_{M} {\sum }_{N} {w}_{i j} ( x , y , z ) \qquad ( 16 )$$

Since the spatial density of the measured 3D points of the individual perspectives j naturally varies strongly, the spatial density of the corrected overall point set is also not homogeneous.

In order to obtain a different spatial density of points, the probability density wᵢⱼ(x, y, z) according to Eq. (13) can be resampled, e.g., with a regular point grid. For example, only points that locally represent a maximum in at least one direction are then included in the resulting set.

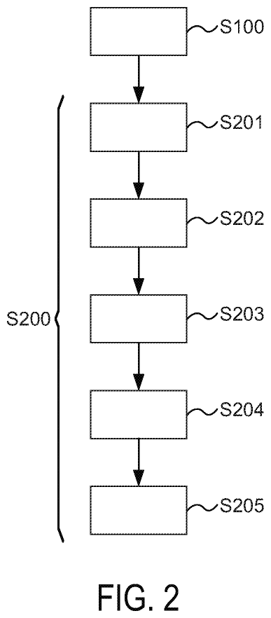

In the following, an exemplary embodiment of a method for processing measured 3D values 10 of a scene 20 is described with reference to a flow diagram shown in FIG. 2. In this embodiment, the method is carried out by means of the system 1 that is schematically and exemplarily shown in FIG. 1, in particular, by means of the processing units 2 comprised thereby.

In step S100, the 3D measurement values 10 are acquired by one or more 3D measurement devices 3₁, 3₂. The 3D measurement values 10 include first 3D measurement values 10₁ acquired from a first perspective and second 3D measurement values 10₂ acquired from a second perspective different from the first perspective. The fields of view of the first perspective and the second perspective at least partially overlap.

In step S200, the 3D measurement values 10 are processed in multiple stages using a hierarchical location uncertainty model which takes into account various measurement errors of the 3D measurement values 10 and/or boundary conditions for the 3D measurement values 10, which are dependent on the geometry of the scene 20 and the first perspective and/or the second perspective. Advantageously, a respective location uncertainty function wᵢⱼ(x, y, z) is determined using the hierarchical location uncertainty model for 3D measurement values of the first 3D measurement values 10₁ and/or for 3D measurement values of the second 3D measurement values 10₂, and this is adapted stepwise.

Preferably, step S200 comprises one or more of the following five sub-steps:

In step S201, using a lowest-stage location uncertainty model for the 3D measurement values of the first 3D measurement values 10₁ and/or for the 3D measurement values of the second 3D measurement values 10₂, a respective location uncertainty function wᵢⱼ(x, y, z) is determined, wherein the lowest-stage location uncertainty model takes into account measurement errors which can be determined for each 3D measurement value of the 3D measurement values 10 independently of the other 3D measurement values of the 3D measurement values 10.

In step S202, the location uncertainty functions wᵢⱼ(x, y, z) for the 3D measurement values of the first 3D measurement values 10₁ and/or the 3D measurement values of the second 3D measurement values 10₂ are adapted using a first higher-stage location uncertainty model, wherein the first higher-stage location uncertainty model takes into account dependencies between the 3D measurement values of the first 3D measurement values 10₁ and/or between the 3D measurement values of the second 3D measurement values 10₂ that result from the geometry of the scene 20 and the respective perspective.

In step S203, the 3D measurement values of the first 3D measurement values 10₁ and the 3D measurement values of the second 3D measurement values 10₂ and the location uncertainty functions wᵢⱼ(x, y, z) for the 3D measurement values of the first 3D measurement values 10₁ and the location uncertainty functions wᵢⱼ(x, y, z) for the 3D measurement values of the second 3D measurement values 10₂ are transferred into a common coordinate system by means of a respective coordinate transformation.

In step S204, the location uncertainty functions wᵢⱼ(x, y, z) for the 3D measurement values of the first 3D measurement values 10₁ and/or the 3D measurement values of the second 3D measurement values 10₂ are adapted using a second higher-stage location uncertainty model, the second higher-stage location uncertainty model taking into account redundancy of the first 3D measurement values 10₁ and the second 3D measurement values 10₂.

In step S205, one or more of the following processing steps is carried out: (i) on the basis of the location uncertainty functions wᵢⱼ(x, y, z) in the common coordinate system, a reliability of the 3D measurement values of the first 3D measurement values 10₁ and/or the 3D measurement values of the second 3D measurement values 10₂ is determined; (ii) on the basis of the location uncertainty functions wᵢⱼ(x, y, z) of corresponding 3D measurement values of the first 3D measurement values 10₁ and the second 3D measurement values 10₂, corrected 3D measurement values are determined; and (iii) on the basis of the location uncertainty functions wᵢⱼ(x, y, z) in the common coordinate system, an overall location uncertainty function w(x, y, z) is determined and by sampling the overall location uncertainty function w(x, y, z) new 3D measurement values are determined.

In the claims, the words “including” and “comprising” do not exclude other elements or steps, and the indefinite article “a” does not exclude a plurality.

A single unit or device may perform the functions of multiple elements recited in the claims. For example, two or more of the at least one first processing unit 2₁, the at least one second processing unit 2₂, the at least one third processing unit 2₃, the at least one fourth processing unit 2₄, and the at least one fifth processing unit 2₅ may be formed as a common unit realizing the functions of these units. In particular, the at least one first processing unit 2₁ and the at least one second processing unit 2₂ may advantageously be formed as a common unit in at least one of the one or more devices 3₁, 3₂ for 3D measurement. Likewise, the at least one third processing unit 2₃, the at least one fourth processing unit 2₄ and the at least one fifth processing unit 2₅ may advantageously be formed as a common unit. This common unit or the at least one third processing unit 2₃, the at least one fourth processing unit 2₄ and the at least one fifth processing unit 2s may, for example, be formed in a device distinct from the one or more devices 3₁, 3₂ for 3D measurement, for example in a computer or the like. The fact that individual functions and/or elements are listed in different dependent claims does not mean that a combination of these functions and/or elements cannot also be advantageously used.

The system 1 may comprise further units not shown in FIG. 1. For example, the system 1 preferably comprises one or more pre-processing units that can be used to perform further processing steps on the 3D measurement values 10. This may comprise, for example, correction of distortions, correction of shading effects in (additionally) captured intensity images, correction of defect pixels, and the like. Additionally or alternatively, the further processing steps may address individual defects of the system 1, for example, by using outlier filters or noise filters. Further, any non-linearities may be corrected at this point or ambiguities may be removed by knowledge of the scene 20.

In describing the system 1 shown in FIG. 1, reference has been made only to the first 3D measurement values 10₁ and the second 3D measurement values 10₂ for simplicity. As can be seen from the figure, the 3D measurement values 10 may comprise other 3D measurement values, for example, third 3D measurement values 10₃ acquired from a third perspective different from the first and second perspectives. The fields of view of the first perspective, the second perspective and/or the third perspective are at least partially overlapping. The 3D measurement values 10, including the further, for example, third 3D measurement values 10₃, may be acquired by one or more 3D measurement devices 3₁, 3₂, 3₃. Processing in the one or more processing units 2 may then be performed accordingly for the 3D measurement values 10. Advantageously, additional redundancy of the further 3D measurement values, for example, the third 3D measurement values 10₃, may be used to further describe the different types of measurement errors of the 3D measurement values 10. In some embodiments, the number of different, at least partially overlapping perspectives may be four, five, six, seven, eight, nine, or more. The additional redundancies may then help to maximize the beneficial effects of the invention.

In the system 1 shown in FIG. 1, the different perspectives are captured simultaneously by several devices 3₁, 3₂, 3₃ for 3D measurement, in this case ToF cameras (this is particularly advantageous for moving scenes). Alternatively, it is also possible for a moving 3D measurement device to capture the different perspectives at different times (this is particularly possible for static scenes). In this case, the number, position, and orientation of the different perspectives are preferably selected in such a way that the scene is captured as completely and without gaps as possible. Instead of the ToF cameras 3₁, 3₂, 3₃, one or more other devices for 3D measurement may also be used. Such a device or devices may use different technologies, such as time-of-flight, structured light, depth from focus, depth from stereo, and so on, or combinations thereof. Where multiple devices are used for 3D measurement, they may be technically identical or they may have different characteristics and may be based on different methods.

In the second location uncertainty model of a higher-stage, further errors can be considered which can be described at this stage over several or all perspectives j. For example, this could include motion artifacts when the 3D measurement values are taken sequentially. In conjunction with the time offsets, it would then be possible to model the closest possible but appropriate location uncertainties. Another effect that could be taken into account at this stage would be de-alignment due to temperature or vibration. One could examine the measured points for alignment/spatial correlation, taking into account the degrees of freedom described, and determine the uncertainty due to de-alignment more finely than is possible at the lowest-stage. Further, errors due to inhomogeneities of the optical medium in which the scene 20 is located could be modeled. An example would be a recording using LIDAR measurements over a distance of several 100 m, where the recording devices are suitably far apart. Air rising due to heat in certain regions changes the refractive index (flicker, lateral error) and the speed of light (z-error).

The reference signs in the claims are not to be understood in such a way that the subject-matter and the scope of protection of the claims are limited by these reference signs.

In summary, a system for processing measured 3D values of a scene has been described. The 3D measurement values include first 3D measurement values acquired from a first perspective and second 3D measurement values acquired from a second perspective different from the first perspective. The fields of view of the first perspective and the second perspective is at least partially overlapping. The 3D measurement values were acquired by one or more 3D measurement devices. The system comprises one or more processing units for multi-stage processing of the 3D measurement values using a hierarchical location uncertainty model that takes into account various measurement errors of the 3D measurement values and/or boundary conditions for the 3D measurement values, which are dependent on the geometry of the scene and the first perspective and/or the second perspective.

1.-14. (canceled)

15. A system for processing measured 3D values of a scene, where-in the 3D measurement values comprise first 3D measurement values acquired from a first perspective and second 3D measurement values acquired from a second perspective different from the first perspective, wherein the fields of view of the first perspective and the second perspective are at least partially overlapping, wherein the 3D measurement values have been acquired by one or more devices for 3D measurement, wherein the system comprises:
one or more processing units for multi-stage processing of the 3D measurement values using a hierarchical location uncertainty model which takes into account various measurement errors of the 3D measurement values and/or boundary conditions for the 3D measurement values, which are dependent on the geometry of the scene and the first perspective and/or the second perspective.

16. The system according to claim 15, wherein the one or more processing units are adapted, using the hierarchical location uncertainty model for the 3D measurement values of the first 3D measurement values and/or for the 3D measurement values of the second 3D measurement values 10₂, to determine a respective location uncertainty function (wᵢⱼ(x, y, z)) and to adapt it in stages.

17. The system according to claim 16, wherein the one or more processing units comprise at least a first processing unit that is adapted, using a lowest-stage location uncertainty model for the 3D measurement values of the first 3D measurement values and/or the 3D measurement values of the second 3D measurement values, to determine a respective location uncertainty function (wᵢⱼ(x, y, z)), wherein the lowest-stage location uncertainty model takes into account measurement errors which can be determined for each 3D measurement value of the 3D measurement values independently of the other 3D measurement values of the 3D measurement values.

18. The system according to claim 17, wherein the lowest-stage location uncertainty model accounts for one or more of the following measurement errors: (i) depth-dependent lateral measurement errors; (ii) measurement errors due to sensor noise of the one or more 3D measurement devices; (iii) measurement errors due to geometric calibration errors; (iv) measurement errors due to linearity errors of the one or more 3D measurement devices; and (v) periodic ambiguities of the 3D measurement values.

19. The system according to claim 16, wherein the one or more processing units comprise at least a second processing unit that is adapted to process the location uncertainty functions (wᵢⱼ(x, y, z)) for the 3D measurement values of the first 3D measurement values and/or the 3D measurement values of the second 3D measurement values using a first higher-stage location uncertainty model, wherein the first higher-stage location uncertainty model takes into account dependencies between the 3D measurement values of the first 3D measurement values and/or between the 3D measurement values of the second 3D measurement values that are dependent on the geometry of the scene and the respective perspective.

20. The system according to claim 19, wherein the first higher-stage location uncertainty model takes into account one or more of the following measurement errors and/or boundary conditions that are dependent on the geometry of the scene and the respective perspective: (i) measurement errors due to scattered light; (ii) measurement errors due to multipath effects; (iii) boundary conditions due to spatially contiguous surfaces in the scene, and (iv) boundary conditions due to 3D edges in the scene.

21. The system according to claim 16, wherein the one or more processing units comprise at least a third processing unit that is adapted to transfer the 3D measurement values of the first 3D measurement values and the 3D measurement values of the second 3D measurement values as well as the location uncertainty functions (wᵢⱼ(x, y, z)) for the 3D measurement values of the first 3D measurement values and the location uncertainty functions (wᵢⱼ(x, y, z)) for the 3D measurement values of the second 3D measurement values into a common coordinate system by means of a respective coordinate transformation.

22. The system according to claim 16, wherein the one or more processing units comprise at least a fourth processing unit that is adapted to process the location uncertainty functions (wᵢⱼ(x, y, z)) for the 3D measurement values of the first 3D measurement values and/or the 3D measurement values of the second 3D measurement values using a second higher-stage location uncertainty model, wherein the second higher-stage location uncertainty model takes into account a redundancy of the first 3D measurement values and the second 3D measurement values that depends on the geometry of the scene, the first perspective and the second perspective.

23. The system according to claim 21, wherein the one or more processing units comprise at least a fifth processing unit that is adapted to perform one or more of the following processing steps: (i) determining, on the basis of the location uncertainty functions (wᵢⱼ(x, y, z)) in the common coordinate system, a reliability of the 3D measurement values of the first 3D measurement values and/or the 3D measurement values of the second 3D measurement values; (ii) determining, on the basis of the location uncertainty functions (wᵢⱼ(x, y, z)) of corresponding 3D measurement values of the first 3D measurement values and the second 3D measurement values; and (iii) determining, on the basis of the location uncertainty functions (wᵢⱼ(x, y, z)) in the common coordinate system, an overall location uncertainty function (w(x, y, z)) and determining new 3D measurement values by sampling the overall location uncertainty function (w(x, y, z)).

24. The system according to claim 15, wherein the system further comprises the one or more devices for 3D measurement.

25. The system according to claim 24, wherein the one or more devices for 3D measurement comprise one or more time-of-flight, ToF, cameras.

26. The system according to claim 17, further comprising the one or more devices for 3D measurement, wherein at least one of the one or more devices for 3D measurement comprises the at least one first processing unit and, optionally, the at least one second processing unit.

27. A method of processing measured 3D values of a scene, wherein the 3D measurement values comprise first 3D measurement values acquired from a first perspective and second 3D measurement values acquired from a second perspective different from the first perspective, wherein the fields of view of the first perspective and the second perspective are at least partially overlapping, wherein the 3D measurement values have been acquired by one or more 3D measurement devices, wherein the method comprises the step of:
multi-stage processing of the 3D measurement values using a hierarchical location uncertainty model which takes into account various measurement errors of the 3D measurement values and/or boundary conditions for the 3D measurement values, which are dependent on the geometry of the scene and the first perspective and/or the second perspective.

28. A computer program comprising instructions which, when the program is executed by a computer, cause the computer to perform the method of claim 27.
